(19) United States
(12) Patent Application Publication
(10) Pub. No.: US 2012/0037085 A1
(43) Pub. Date: Feb. 16, 2012

(54) ENCLOSED BATHING APPARATUS FOR ANIMALS

(76) Inventor: DAVID CAISSE, Sebring, FL (US)

(21) Appl. No.: 13/195,502

(22) Filed: Aug. 1, 2011

Related U.S. Application Data
(60) Provisional application No. 61/372,925, filed on Aug. 12, 2010.

(51) Int. Cl. A01K 13/00

(52) U.S. Cl. 119/676

(57) ABSTRACT

An enclosed bathing apparatus for animals includes an enclosure having a floor, a front wall, a rear wall that is taller than the front wall, a pair of side walls, and a top wall connected to each of the rear and side walls. A gate for allowing access to the interior of the enclosure is provided and includes a locking mechanism for securing the gate in an open or closed position. One or more attachment units are provided for securing an animal inside the enclosure and a water ingress and egress is provided.

### CROSS-REFERENCE TO RELATED APPLICATIONS

This application claims the benefit of U.S. Application Ser. No. 61/372,925 filed on 12 Aug., 2010. The contents of this application are incorporated herein by reference.

### BACKGROUND

1. Field of the Invention

The present invention relates generally to animal bathing devices, and more particularly to an enclosed bathing apparatus for safely containing a pet.

2. Description of Related Art

As any pet owner will attest, domesticated animals do not typically cooperate when being bathed. As such, many pet owners prefer to employ the services of a professional groomer to clean their pets such as dogs and cats. However, groomers must often juggle multiple tasks and cannot stop all other activities each time an animal is in a bathing tub.

Though there are many known devices for restraining animals including straps and leashes, a groomer with limited staff often finds such devices inappropriate for use with a bathing apparatus. This is because, in addition to being ineffective, they also create an additional safety concern. For instance, if an animal attempts to jump out of the bath, the strap or leash can wrap around its neck, restricting airflow or causing other harm to the animal. For this reason, the groomer must always strive to remain within arm's length of the animal during the entire bathing process. This requirement deleteriously affects the efficiency of the groomer by precluding other duties such as pick-ups, drop-offs and cashiering, for example.

Accordingly, the need exists for a bathing apparatus capable securely and safely restraining an animal both before, during and after a grooming session without the limitations of the above noted devices.

### SUMMARY OF THE INVENTION

The present invention is directed to an enclosed bathing apparatus for animals. One embodiment of the present invention can include an enclosure having a floor, a front wall, a rear wall that is taller than the front wall, a pair of side walls, and a top wall connected to each of the rear and side walls. A gate for allowing access to the interior of the enclosure is provided and includes a locking mechanism for securing the gate in an open or closed position. One or more attachment units are provided for securing an animal inside the enclosure and a water ingress and egress is provided.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal elevation of an enclosed bathing apparatus for animals that is useful for understanding the inventive concepts disclosed herein.

FIG. 2 is a partial exploded parts view of an enclosed bathing apparatus for animals in accordance with one embodiment of the invention.

FIG. 3 is a perspective view of an enclosed bathing apparatus for animals in accordance with one embodiment of the invention.

FIG. 4 is a perspective view of an enclosed bathing apparatus for animals in operation, according to one embodiment of the invention.

FIG. 5 is a perspective view of an enclosed bathing apparatus for animals in accordance with another embodiment of the invention

FIG. 6a is perspective view of an additional embodiment of the invention.

FIG. 6b is a side view of an additional embodiment of the invention.

FIG. 6c is a side view of an additional embodiment of the invention.

FIG. 6d is a side view of an additional embodiment of the invention.

FIG. 7a is a front view of an enclosed bathing apparatus for animals in accordance with an alternate embodiment of the invention.

FIG. 7b is another front view of an enclosed bathing apparatus for animals in accordance with an alternate embodiment of the invention.

FIG. 8a is a front view of an enclosed bathing apparatus for animals in accordance with another alternate embodiment of the invention.

FIG. 8b is another front view of an enclosed bathing apparatus for animals in accordance with another alternate embodiment of the invention.

### DETAILED DESCRIPTION OF THE INVENTION

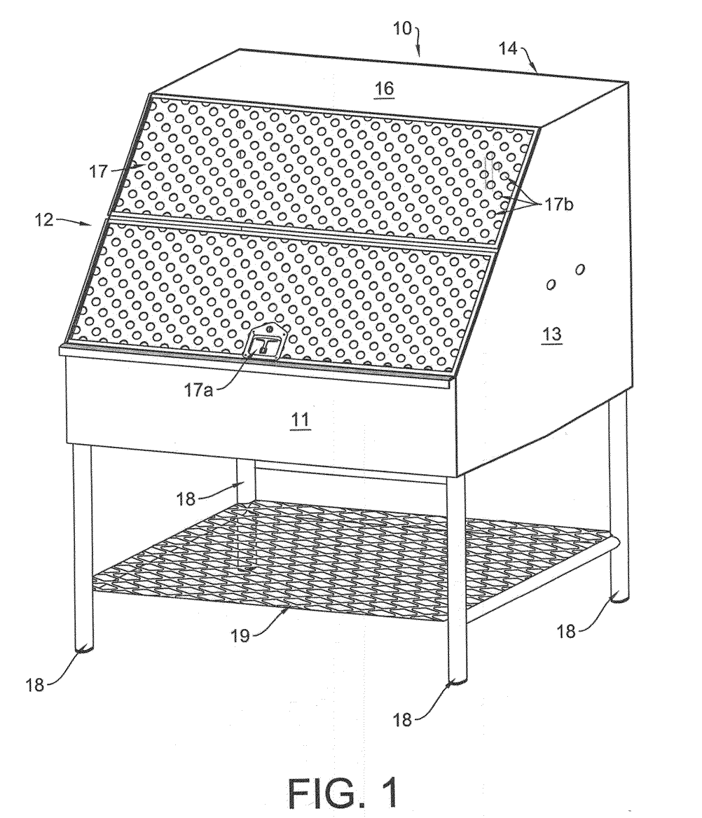

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. For purposes of this description, the terms “upper,” “bottom,” “right,” “left,” “front,” “vertical,” “horizontal,” “top,” “bottom” and derivatives thereof shall relate to the invention as oriented in FIG. 1.

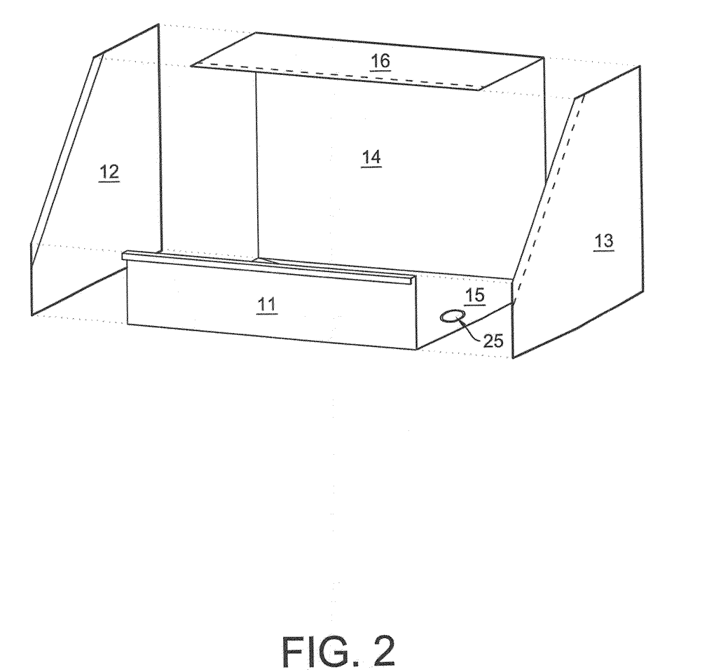

FIGS. 1 and 2 illustrate one embodiment of an enclosed bathing apparatus for animals 10 (bath) that is useful for understanding the inventive concepts disclosed herein. As shown, bath 10 can include a front wall 11, side walls 12 and 13 and a back wall 14 projecting upward from a bottom wall 15 thus creating a watertight tub. Additionally, bath 10 can also include a top wall 16, a gate 17 and optional telescoping legs 18 having a shelf 19 secured thereto.

Bottom wall 15 acts as the base of the bath. In one embodiment, bottom wall 15 can include a sloped surface for directing water toward an outlet opening or drain 25 disposed along a the bottom of the bath (See FIG. 2). As will be appreciated, drain 25 can preferably be located at the lowermost portion of the bottom wall 15 so that any liquid contained within the bath can be directed into the drain 25.

In one preferred embodiment, each of walls 11-16 can be constructed from metallic elements such as stainless steel or sheet metal joined by welds to form the bath, however any number of other materials and methods of manufacture are also contemplated. For instance, walls 11-16 can also be molded from a durable non-corrosive material, such as plastic, utilizing any suitable method of manufacture (e.g. injection molding, stamping or machining, for example).

Shelf 19 can be positioned along a lower periphery of the bath 10 in order to provide storage and/or support for the telescoping legs. The telescoping legs 18 can act to raise and lower the height of the bath itself. Telescoping legs and their associated hardware are extremely well known in the art, and no further description will be provided.

Gate 17 can act to securely position an animal inside the bath. As such, gate 17 can be secured along the front periphery of the top wall 16 and can extend downward along side walls 12 and 13 until resting along the top periphery of the front wall 11, thus forming a complete enclosure. As shown, gate 17 can include a latch 17a for allowing a user to open and close the gate and for providing a means for securing the gate 17 in an open or closed position. Additionally, gate 17 can also include a plurality of openings 17b in order to allow an animal located inside the bath to be visible to a user but unable to escape.

In one preferred embodiment, gate 17 can be constructed from lightweight steel mesh having excellent durability and tensile strength. However, other materials such as soft or hardened plastic, fiber netting and/or composite materials, for example, can also be utilized. Although described above as including a specific gate configuration, one of skill in the art will recognize that many variations can also be implemented without deviating from the scope and spirit of the inventive concepts disclosed herein.

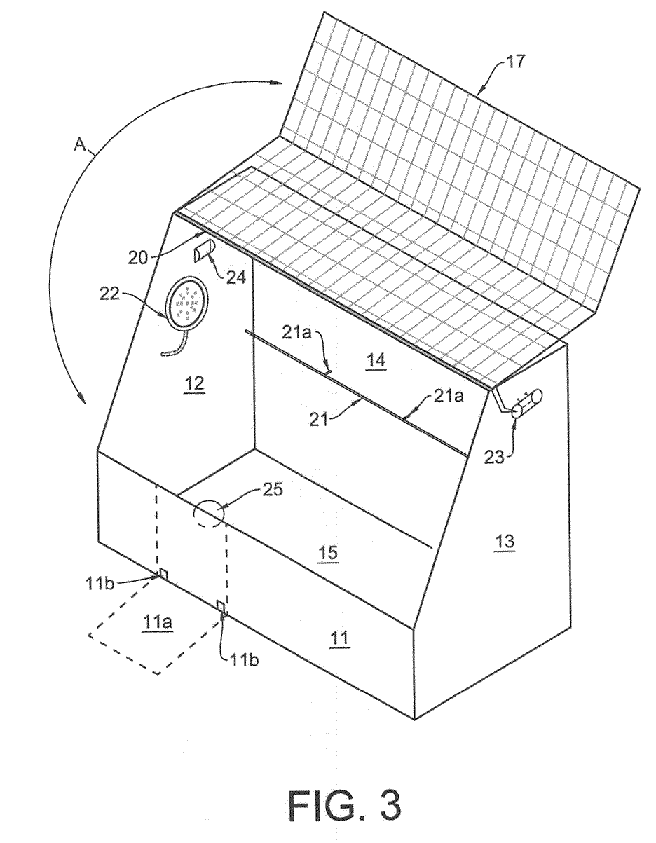

FIG. 3 illustrates one embodiment of the bath 10 with the gate 17 in an open position. As shown, gate 17 can be secured to the top wall 16 via one or more hinges 20 in order to rotate from a closed position to an open position as illustrated by arrow A. Additionally, front wall 11 can include an optional access door 11a. Access door 11a can be removable, or can be configured to rotate along a bottom axis via one or more hinges 11b, for example, in order to create a ramp for animals to enter the bath. Alternatively, door 11a can be configured to rotate about a side axis in order to swing inward or outward, or can include a slide rail in order to move along a parallel axis to that of the front wall 11. To this end, door 11a can include a waterproof seal and the corresponding known hardware for allowing the door to operate in a manner consistent with that described above, while still allowing the bath to retain water.

As further illustrated in FIG. 3, the bath 10 can also include a plurality of additional features such as: one or more animal restraints 21, a shower 22, an electric motor 23 and one or more lighting elements 24. As shown, animal restraint 21 can be secured to an inside wall of the bath and can be used to physically restrict the movement of an animal located inside the enclosure. In one preferred embodiment, restraint 21 can be constructed from an elongated steel tubular member that is permanently affixed to the back wall 14 via one or more spacers 21a. Of course other materials, shapes and sizes are also contemplated.

Shower 22 can be connected to an external water supply in a conventional manner and can preferably include an integral flow control mechanism for allowing a groomer to adjust the spray of water from any position. Showers of this type are well known in the art, and no further description will be provided.

One or more optional opening devices such as an electric motor 23 can be secured to the hinge 20 or gate 17 in order to allow a user to open and close the gate with the push of a button. As described herein, virtually any known AC or DC powered motor (and corresponding components) can be utilized. Of course other opening devices such as gas struts, and mechanical springs, for example, can also be utilized. As each of these items are extremely well known in the art, and no further description will be provided.

One or more waterproof lighting elements 24 such as an LED, for example, can be provided in order to allow for improved visibility of and within the bath 10. These lights 24 can be placed within the inside of the bath, or can be affixed to an outside portion of the apparatus. Although described above as utilizing LED, one of skill in the art will recognize that any suitable lighting elements having a waterproof or water resistant feature can be utilized.

As described herein, one or more elements of the enclosed bathing apparatus for animals 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the front wall 11, side walls 12 and 13, back wall 14, bottom wall 15, top wall 16, gate 17 telescoping legs 18 and shelf 19, among others, for example, may be formed together as one continuous element, either through manufacturing processes, such as welding, casting, or molding, or through the use of a singular piece of material milled or machined with the aforementioned components forming identifiable sections thereof.

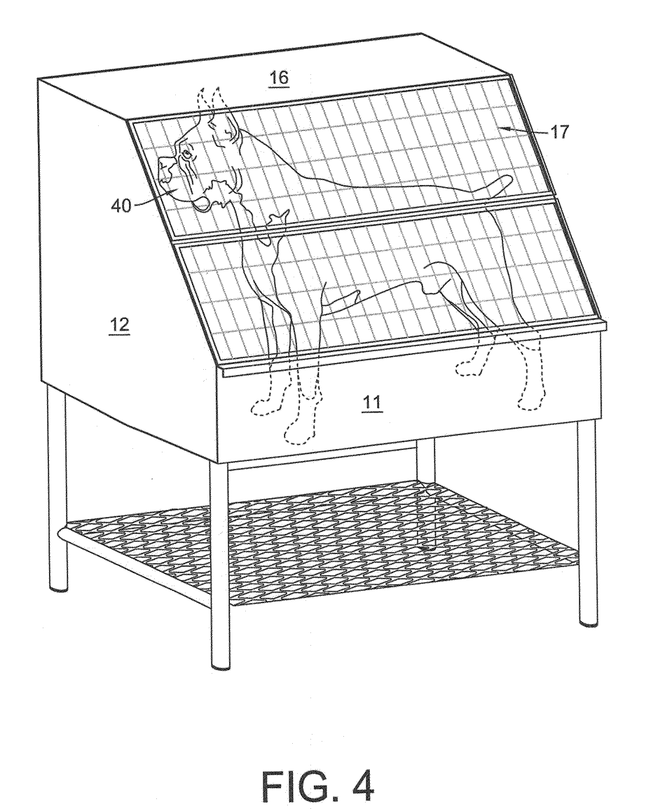

In operation, and as illustrated in FIG. 4, a pet 40 can be safely and securely positioned inside the bath 10. Moreover, in the unlikely event that water is left running and the drain 25 becomes clogged, the animal can be protected against harm by the low height of the front wall 11 and the openings of the gate 17.

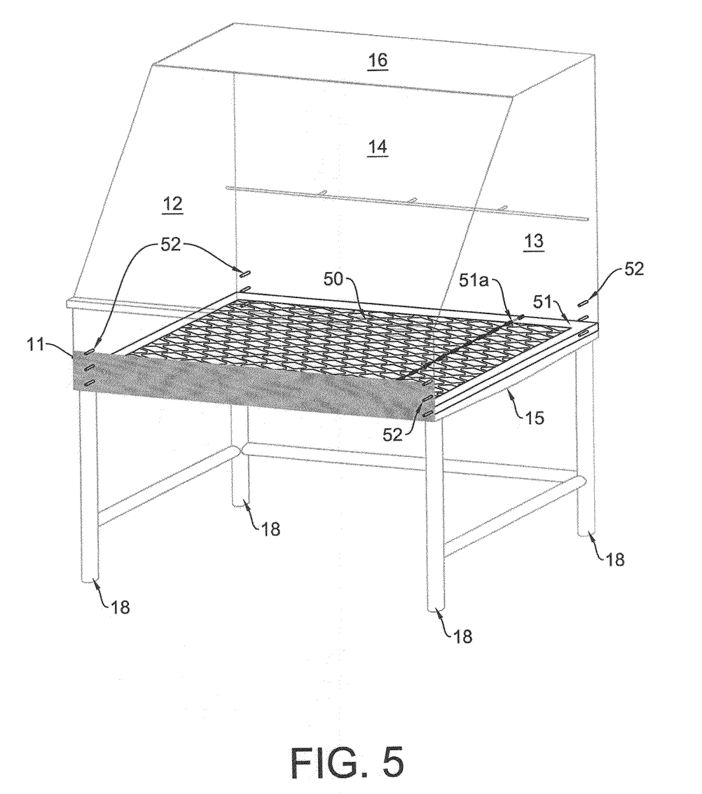

FIG. 5 illustrates another embodiment of an enclosed bathing apparatus for animals 10 that further includes an adjustable floor 50. The adjustable floor 50 can be positioned on the pegs 52 so as to be raised and lowered along the front, back and side walls, thus allowing the device to accommodate varying sizes of pets. Additionally, adjustable floor 50 can include an access end 51 having a hinge 51a or other similar device capable of allowing a portion of the floor 50 to be removed in order to access the drain of the bath without requiring the animal to be removed. Access end can operate as a stand alone portion of the adjustable floor which can be removed, or can be connected to the raised floor 50 via a hinge (not shown). In one preferred embodiment, adjustable floor 50 and access end 51 can be constructed from flattened expanded metal or other similar materials having a two way locking hinge 52 interposed therebetween.

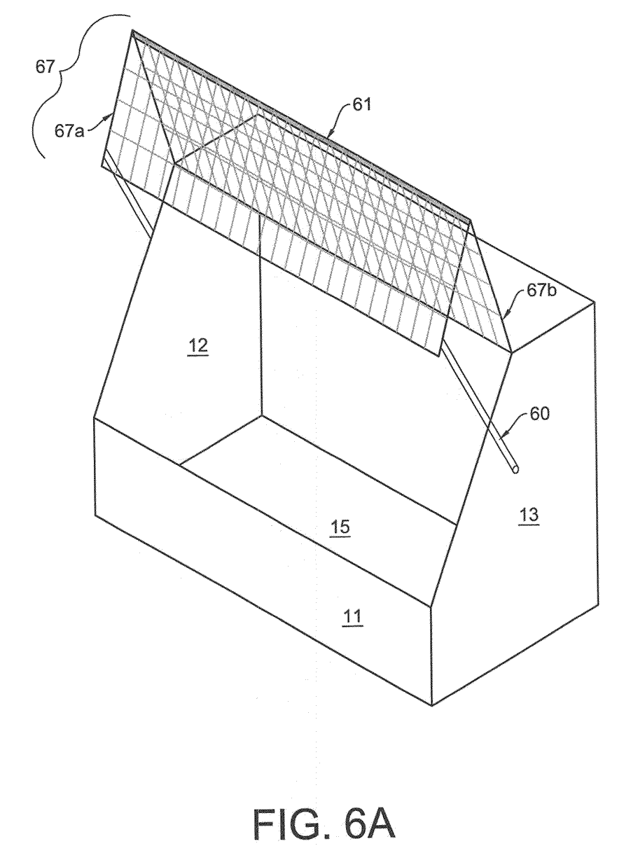

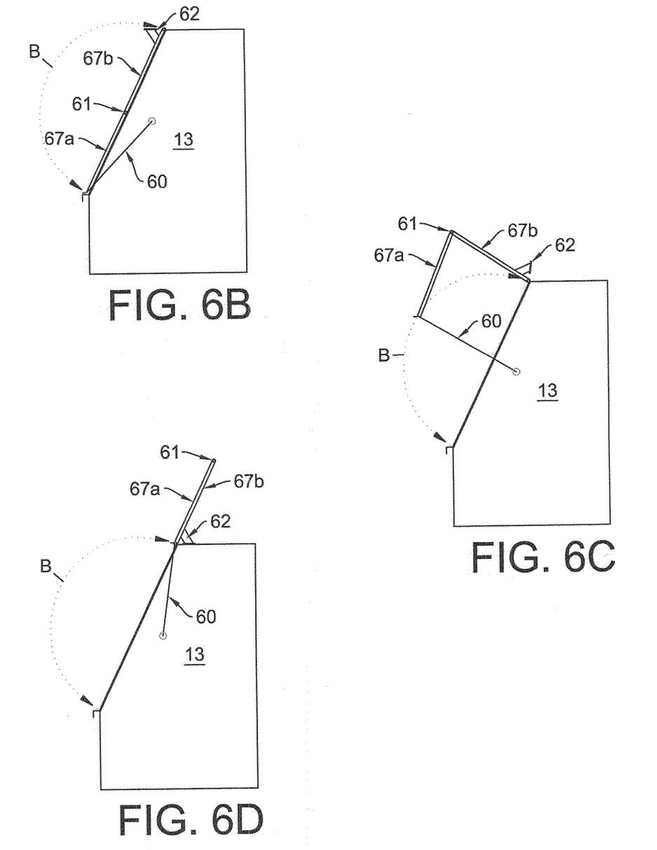

FIGS. 6a-6d illustrate an alternate embodiment of a tub 10 that further includes a stabilizing arm 60 connected to a bi-fold gate 67. As shown, gate 67 can include two substantially identical members 67a and 67b connected via a hinge 61. To this end, stabilizing arm 60 can act to raise and lower gate 67 along axis B into an open or closed position. In one preferred embodiment, the gate 67 can further include a protrusion 62 for allowing the gate to rest along the top 16 of the bath in an open position.

As described herein, stabilizing arm 60 can be constructed from a single piece of hardened material such as metal or can include a hydraulic, gas shock, spring mechanism or other such device capable of assisting a user in opening and closing the gate. Finally, in another embodiment (not shown) gate 67 can be secured to a spindle or other known rotational device located atop the bath which can be rotated to open and close the gate. Devices such as these being extremely well known in the art, no further description will be provided.

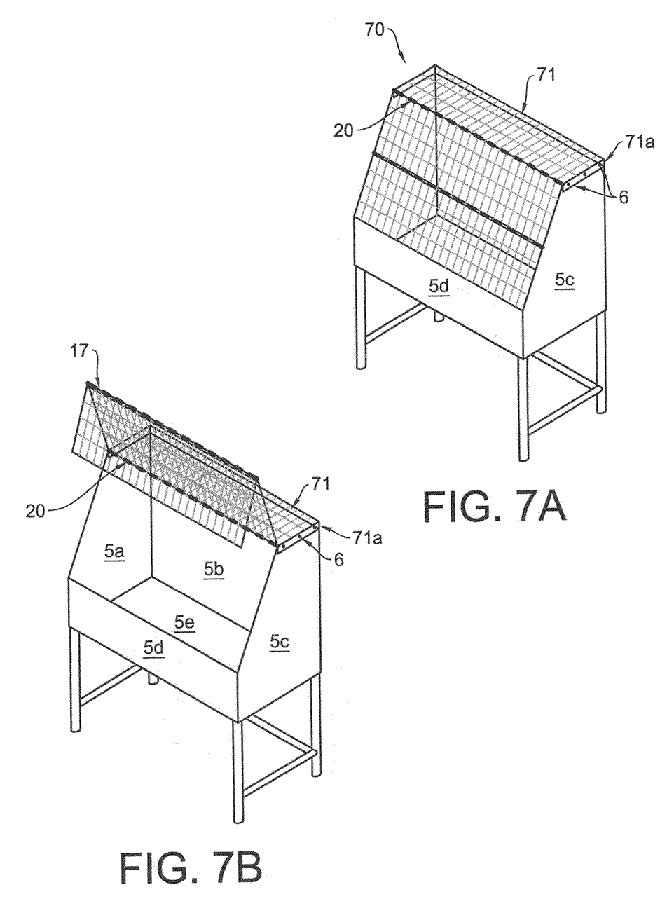

FIGS. 7A and 7B illustrate another alternate embodiment of an enclosed bathing apparatus for animals that includes an enclosure 70 configured to be secured to a traditional open top groomers bath 5 having four vertical walls 5a-5d attached to a generally planar base 5e.

As shown, enclosure 70 can include top portion 71, a gate 17 and one or more hinges 20. The top portion 71 can be positioned atop the traditional tub so as to rest on the side and back panels 5a-5c. Additionally, the top portion can include angled edges 71a configured to be secured to the top of the tub walls 5a and 5c via traditional mounting hardware 6 such as screws and bolts for example.

The gate 17, as described in the preceding examples can be secured to the front edge of the top portion 71 via a hinge 20 and can act to securely position an animal inside the bath.

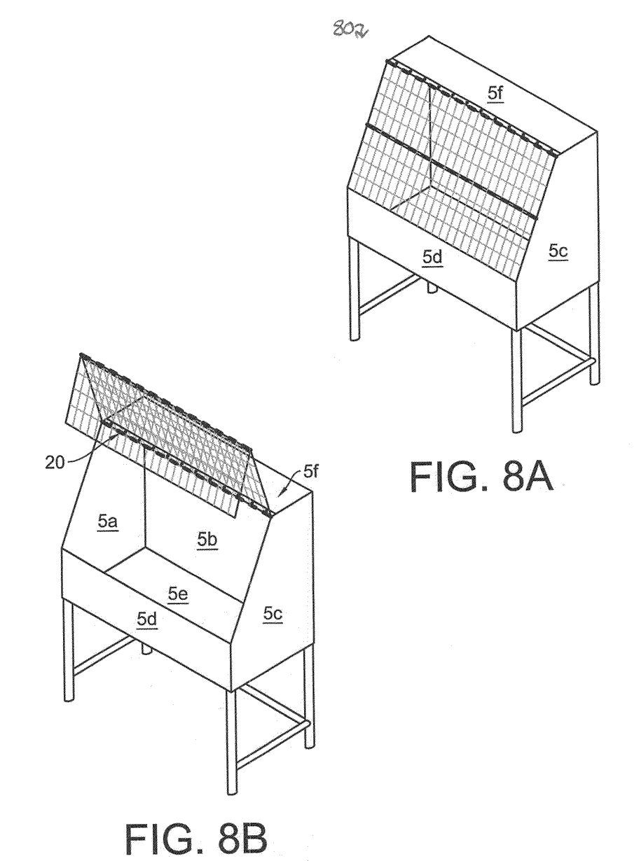

FIGS. 8A and 8B illustrate yet another alternate embodiment of an enclosed bathing apparatus for animals that that includes an enclosure configured to be secured to a traditional closed top groomers bath 5 having four vertical walls 5a-5d attached to a generally planar base 5e and a planar top 5f.

As shown, enclosure 80 can include a hinge 20 secured to the front edge of the top portion of the tub 5f and a gate 17. The gate 17, as described in the preceding examples can act to securely position an animal inside the bath.

As described above with regard to FIGS. 7 and 8, the inventive concepts described herein can be utilized by individuals who have already invested in a traditional style grooming table but desire the safety and functionality provided by the present invention. Moreover, although described with reference to gate 17, each of the enclosures 70 and 80 can also include the bi-fold gate 67 and a stabilizing arm 60 as described above with reference to FIG. 6.

Finally, although not illustrated, the enclosure 80 can also be mounted directly to a wall onto which a traditional tub is positioned. Such a feature can allow the inventive concepts to be utilized on traditional tubs that could not support the additional weight of the enclosure 80.

Accordingly, an enclosed bathing apparatus for animals as described herein can securely and safely restrain an animal in a bathing chamber with or without the direct supervision of a groomer.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An enclosed bathing apparatus for animals, comprising:
an enclosure having a floor, a front wall, a rear wall, a pair of side walls, and a top wall; and
a gate pivotally secured to the top wall, said gate being configured to be removably attached to each of said front and side walls,
wherein the gate is further configured to provide access to an interior portion of the enclosure; and
a drain unit secured to the floor, said drain unit being configured to allow water to be removed from the enclosure.

2. The enclosed bathing apparatus for animals of claim 1, wherein said gate further includes a plurality of openings for allowing the interior of the enclosure to be visible.

3. The enclosed bathing apparatus for animals of claim 1, wherein said gate further includes a locking mechanism for securing the gate in at least one of an open and closed position.

4. The enclosed bathing apparatus for animals of claim 1, wherein said gate includes at least two members connected via a center hinge, said members being configured to rotate about the hinge when the gate is transitioned between an open and a closed position.

5. The enclosed bathing apparatus for animals of claim 1, further comprising at least one of:
an electric motor, a hydraulic arm, a spring assist opening unit, and a stabilizing arm configured to transition the gate between the open and closed position.

6. The enclosed bathing apparatus for animals of claim 1, further comprising an access door positioned within the front wall.

7. The enclosed bathing apparatus for animals of claim 6, wherein said access door is configured to rotate about a bottom axis in order to act as a ramp for allowing an animal to enter the enclosure.

8. The enclosed bathing apparatus for animals of claim 6, wherein said access door is removable.

9. The enclosed bathing apparatus for animals of claim 1, further including one or more securing units configured to securely restrain an animal within the enclosure

10. The enclosed bathing apparatus for animals of claim 1, further comprising one or more shower units configured to deposit water into the apparatus.

11. The enclosed bathing apparatus for animals of claim 1, further comprising one or more waterproof lights configured to provide illumination to the enclosure.

12. The enclosed bathing apparatus for animals of claim 1, further comprising an adjustable animal floor configured to position animals within the enclosure at a plurality of different heights above the enclosure floor.

13. The enclosed bathing apparatus for animals of claim 13, wherein said adjustable animal floor further includes an access panel for allowing a user to access the drain of the enclosure floor.

14. The enclosed bathing apparatus for animals of claim 1, further comprising a plurality of telescoping legs connected to a bottom portion of the enclosure, said legs being configured to raise and lower a height of the enclosure.

15. An enclosed bathing apparatus for animals configured to be secured to an enclosure having a floor, a front wall, a rear wall, a pair of side walls, and a top wall, said apparatus comprising:
a gate configured to be pivotally secured along a periphery of the top wall and configured to be removably attached to each of said front and side walls, said gate being configured to provide access to an interior portion of the enclosure; and
a hinge interposed between the gate and the top wall.

16. The enclosed bathing apparatus for animals of claim 15, wherein said gate includes at least two members connected via a center hinge, said members being configured to rotate about the center hinge when the gate is transitioned between an open and a closed position.

17. The enclosed bathing apparatus for animals of claim 16, further comprising at least one of:
an electric motor, a hydraulic arm, a spring assist opening unit, and a stabilizing arm configured to transition the gate between the open and closed position.

18. An enclosed bathing apparatus for animals configured to be secured to an enclosure having a floor, a front wall, a rear wall, and a pair of side walls, said apparatus comprising:
a generally planar top wall configured to make contact with each of the pair of side walls and rear wall, said top wall including a pair of downward facing protrusions configured to be secured to each of the side walls via a mounting hardware;
a gate pivotally secured along a front periphery of the top wall and configured to be removably attached to each of said front and side walls,
wherein the gate is configured to provide access to an interior portion of the enclosure; and
a hinge interposed between the gate and the top wall.

19. The enclosed bathing apparatus for animals of claim 18, wherein said gate includes at least two members connected via a center hinge, said members being configured to rotate about the center hinge when the gate is transitioned between an open and a closed position.

20. The enclosed bathing apparatus for animals of claim 19, further comprising at least one of:
an electric motor, a hydraulic arm, a spring assist opening unit, and a stabilizing arm configured to transition the gate between the open and closed position.
